(19) United States
(12) Patent Application Publication
(10) Pub. No.: US 2008/0150953 A1
(43) Pub. Date: Jun. 26, 2008

(54) Buffer management for video data provided asynchronously relative to display device

(76) Inventors: Joseph G. Warner, Tempe, AZ (US); Ram R. Rao, Portland, OR (US); Craig R. Haymond, Chandler, AZ (US)

Correspondence Address: BUCKLEY, MASCHOFF & TALWALKAR LLC, 50 LOCUST AVENUE, NEW CANAAN, CT, 06840, US

(21) Appl. No.: 11/645,384

(22) Filed: Dec. 26, 2006

(51) Int. Cl. G09G 5/36

(52) U.S. Cl. 345/548

(57) ABSTRACT

A method includes storing a frame of video data in a location in a memory. A pointer to the location is transmitted to a queue manager circuit. The pointer is stored in a queue. The pointer is transmitted from the queue to an interface unit. The pointer is then transmitted from the interface unit to a video display controller.

### BACKGROUND

It is increasingly common for video signals to be viewed via a display device that is controlled by a video display controller, in a similar fashion to a display for a computer system. The system which includes the display device may also include one or more sources of the video signals, such as a hardware video decoder (e.g., in a DVD player), a software video decoder, and a hardware video capture device. The display device may be arranged to display the video signal provided to it at a particular resolution, scanning pattern and timing, but the signal provided by the currently selected source may be asynchronous relative to the display device, and may also be different in terms of scan pattern and resolution. The present disclosure is particularly concerned with handling differences between the timing at which the display device displays video data frames, and the timing at which the selected video data source produces the video data frames.

### BRIEF DESCRIPTION OF THE DRAWINGS

FIG. 1 is a high level block diagram of a system provided according to some embodiments.

FIG. 2 is a block diagram that illustrates aspects of a video signal decoding and buffering block that is part of the system of FIG. 1.

FIGS. 3-5 are flow charts that illustrate processes that may be performed by a “frame tracker” block that is part of the circuitry of FIG. 2.

FIGS. 6A and 6B together form a flow chart that illustrates a process that may be performed by the circuitry of FIG. 2.

### DETAILED DESCRIPTION

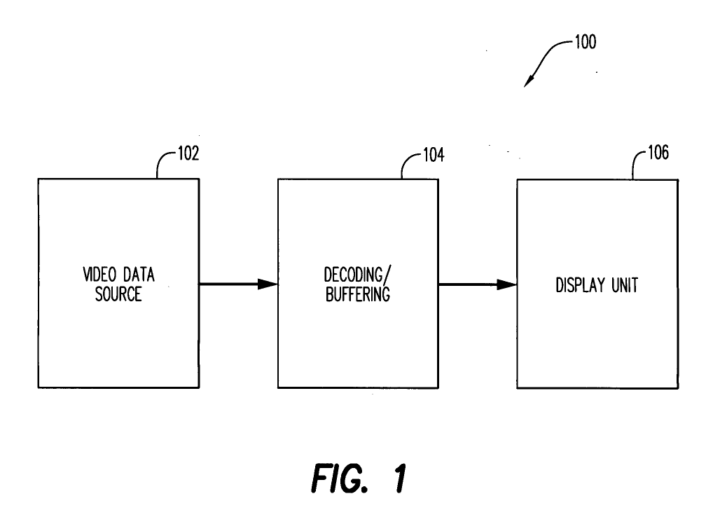

FIG. 1 is a high level block diagram of a system 100 that may be provided according to some embodiments. The system 100 includes a source 102 of video data, a video signal decoding/buffering block 104 coupled to the video data source 102, and a display device 106 which is coupled to the video signal decoding/buffering block 104. The video data source 102 may, for example, be a video data receiver, a modem or other device that receives a stream of video data, a device that reproduces a stream of video data from a storage medium such as a DVD or a hard disk drive, or a device that captures images and generates video signals from the captured images. The video signal decoding/buffering block 104 is described in further detail below. The display device 106 may be a conventional CRT or flat panel display, for example.

Except for aspects of the video signal decoding/buffering block 104, as described below, the system 100 may be conventional in construction and in operation. The system may include other features, which are not explicitly shown in the drawings, such as a user interface, a microprocessor or microcontroller that controls over-all operation of the system, sound reproduction equipment, etc.

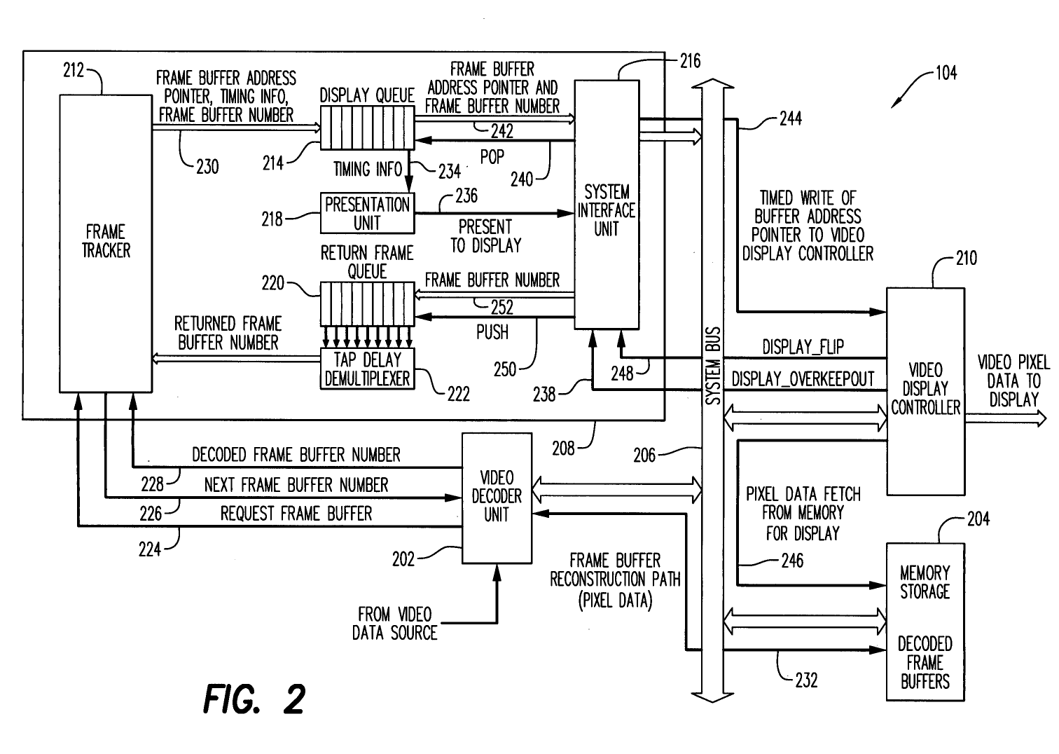

FIG. 2 is a block diagram that illustrates aspects of a video signal decoding and buffering block 104. The decoding/buffering block 104 includes a video decoder unit 202 that receives from the video data source 102 (FIG. 1, not shown in FIG. 2) a video signal to be decoded.

The decoding/buffering block 104 further includes a main data storage memory 204 which is coupled to the video decoder unit 202 via a system bus 206. The video decoder unit 202 decodes, generally in accordance with conventional practices, the video signal that it receives from the video data source, and stores the resulting frames of video data in the data storage memory 204. Certain aspects of the operation of the video decoder unit 202, including its interaction with the frame buffer/queue manager 208, are believed to be novel and are described below.

The decoding/buffering block 104 further includes the above-mentioned frame/buffer queue manager 208. Details of the frame/buffer queue manager 208 are described below. The frame buffer/queue manager 208 is coupled to the system bus 206, and also exchanges signaling with the video decoder unit 202.

Still further, the decoding/buffering block 104 includes a video display controller 210. The video display controller 210 is coupled to the system bus 206 and to the display device 106 (FIG. 1, not shown in FIG. 2). The video display controller 210 also exchanges signals with the frame buffer/queue manager 208. As will be seen, a result of the interaction between the frame buffer/queue manager 208 and the video display controller 210 is that the frame buffer/queue manager 208 effectively controls the sequence of video data frames that the video display controller 210 retrieves from the data storage memory 204 for display on the display device 106.

To summarize a process that will later be described in more detail, the video display controller 210 drives the display device 106 to display frames of video data retrieved by the video display controller 210 from the data storage memory 204 via the system bus 206. The frame buffer/queue manager 208 effectively controls which frames the video display controller retrieves from the data storage memory 204 and allows the timing at which frames are received in the data storage memory 204 to be adapted to the timing at which the video display controller 210 requires frames to be provided to it.

Except for its interaction with the frame buffer/queue manager 208, the video display controller 210 may operate generally in accordance with conventional principles. The video display controller 210 may, if required, perform conventional resolution and scan format conversion with respect to the frames of video data that it retrieves from the data storage memory 204. Further, the video display controller may include a display buffer for the converted video data. The display buffering capability of the video display controller 210 is not separately indicated, but may be considered a “front” or downstream buffer relative to the data storage memory 204, which serves as a “back” buffer.

Details of the frame buffer/queue manager 208 will now be described, with further reference to FIG. 2.

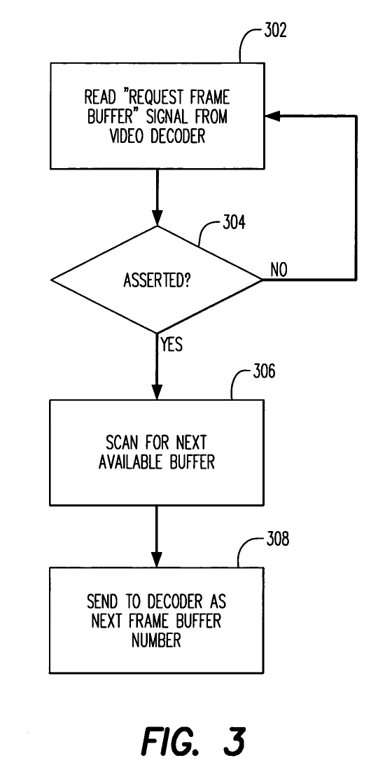

The frame buffer/queue manager 208 includes a frame tracker block 212. The frame tracker block 212, among other functions, interacts with the video decoder unit 202 to guide the video decoder unit's usage of the data storage memory 204. Details of the operation of the frame tracker block 212 will be described below in connection with FIGS. 3-5.

The frame buffer/queue manager 208 further includes a display queue 214. The display queue 214 is coupled to the frame tracker block 212 and, as will be seen, stores a sequence of memory address pointers and other information with respect to a sequence of video data frames that the video decoder unit 202 has stored in the data storage memory 204.

Still further, the frame buffer/queue manager 208 includes an interface unit 216. The interface unit 216 is coupled to the display queue 214 and provides an interface between the frame buffer/queue manager 208 and the video display controller 210. The interface unit 216 selectively receives memory address pointers from the display queue 214 and selectively transmits the memory address pointer to the video display controller 210.

In addition, the frame buffer/queue manager 208 includes a presentation unit 218. The presentation unit 218 is coupled to the display queue 214 and to the interface unit 216. The presentation unit 218 receives from the display queue 214 timing information with respect to the frames of video data effectively queued by the display queue 214. As will be seen, the presentation unit 218 effectively controls the timing at which the interface unit 216 transmits the memory address pointers to the video display controller 210.

Further, the frame buffer/queue manager 208 includes a return frame queue 220. The return frame queue 220 is coupled to the interface unit 216 to receive and store the frame buffer numbers corresponding to frames for which the pointers were transmitted from the interface unit 216 to the video display controller 210. The return frame queue 220 also is coupled to the frame tracker block 212 via a demultiplexer 222, to supply the transmitted frame buffer numbers to the frame tracker block 212.

FIG. 3 is a flow chart that illustrates an aspect of operation of the frame tracker block 212. Specifically, the process illustrated in FIG. 3 is concerned with handling requests, from the video decoder unit 202, for the identity of locations in the data storage memory 204 at which the video decoder unit 202 may store decoded frames of video data.

At 302 in FIG. 3, the frame tracker block 212 reads the signal connection 224 (FIG. 2) via which the video decoder unit 202 indicates its need for a new frame buffer location. It will be understood that the video decoder unit 202 may assert the corresponding “request frame buffer” signal each time the video decoder unit 202 is undertaking (or has completed) decoding of the current video signal frame received by the video decoder unit 202 from the video data source 102 (FIG. 1).

At 304 in FIG. 3, the frame tracker block 212 determines whether the “request frame buffer” signal has been asserted by the video decoder unit 202. If not, then the process of FIG. 3 loops back to 302/idles. However, if it is determined at 304 that the video decoder unit 202 has asserted the “request frame buffer” signal, then the process of FIG. 3 advances to 306. At 306, the frame tracker block 212 scans status registers (which are not separately shown, but may be internal to the frame tracker block 212) that indicate the current status of the frame buffer locations in the data storage memory 204. The purpose of the frame tracker block 212 scanning the status registers is to find a frame buffer location that is available to receive the next frame of decoded video data produced by the video decoder unit 202. For example, the frame tracker block 212 may first examine a register that is pointed to by an index value to determine whether the register indicates that the status of the frame buffer location that corresponds to the register is “locked”. If not, then the next available frame buffer location has been identified, and the process of FIG. 3 may advance to 308. At 308, the frame tracker block 212 sends (via signal path 226) to the video decoder unit 202 the number of the frame buffer location that was found to be available. If the register pointed to by the index value indicates that the corresponding frame buffer location has the status “locked”, then the index may be incremented and the frame tracker block 212 may examine the status of the next frame buffer location. This may continue until the frame tracker block 212 finds a frame buffer location status register that indicates that the corresponding frame buffer location is not locked (i.e., is available). Once the frame tracker block 212 finds an available frame buffer location, the process of FIG. 3 advances to 308, as described above.

In the event that no frame buffer is available, then the frame tracker block 212 may refrain from sending the next frame buffer location number to the video decoder unit 202. The video decoder unit 202 may then stall, for lack of a buffer in which to store the next decoded frame of video data. Consequently, a frame that is being displayed by the video display controller 210 may be repeated.

In some embodiments, the frame tracker block 212 may also send to the video decoder unit 202 the physical address of the frame buffer location that corresponds to the next frame buffer number. In other embodiments, the video decoder unit 202 may directly or indirectly use the next frame buffer number to look up the physical address of the frame buffer location that corresponds to the next frame buffer number.

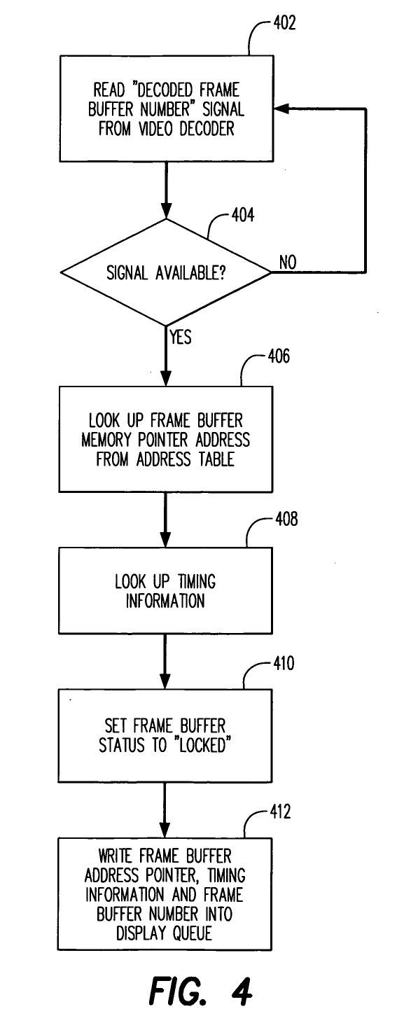

FIG. 4 is a flow chart that illustrates another aspect of operation of the frame tracker block 212. In particular, the process illustrated in FIG. 4 is concerned with activities that the frame tracker block 212 performs to populate the display queue 214.

At 402 in FIG. 4, the frame tracker block 212 reads the “decoded frame buffer number” signal connection 228 (FIG. 2) provided from the video decoder unit 202 to the frame tracker block 212. This signal may be provided by the video decoder unit 202 as a result of the video decoder unit 202 decoding the “next frame buffer number” indication that was most recently provided by the frame tracker block 212 as indicated at 308 in FIG. 3. At 404 in FIG. 4, the frame tracker block 212 determines whether the “decoded frame buffer number” signal is available from the video decoder unit 202. If not, the process loops back to 402/idles. However, if at 404 the frame tracker block 212 determines that the “decoded frame buffer number” signal is available, then the process of FIG. 4 advances to 406.

At 406, the frame tracker block 212 uses the decoded frame buffer number to access from a memory table (not shown) the frame buffer pointer address (i.e., the physical address) for the frame buffer location in data storage memory 204 which corresponds to the decoded frame buffer number. (It will be appreciated that the look-up of the pointer address may be thought of as including transmission of the pointer address from the table to the frame tracker block.) In association with 406 (before, during or after), the frame tracker block 212 also performs an operation 408. In 408 the frame tracker block 212 looks up timing information from a timing information table (not shown). The timing information relates to the timing at which the frame of video data (i.e., the frame stored or to be stored in the buffer location pointed to by the frame buffer pointer address) is to be displayed. The timing information may include a presentation time stamp and a TFF/BFF flag. (As is known to those who are skilled in the art, the TFF/BFF flag is a guide as to which set of alternate display lines are to be drawn in the case of an interlaced video signal.)

At 410, the frame tracker block 212 sets to “locked” the status indicated by the register (not separately shown) that corresponds to the frame buffer location for the decoded frame buffer number. At 412, the frame tracker block 212 stores (as indicated at 230 in FIG. 2) in the display queue 214, as the next entry in the display queue, the frame buffer number and the frame buffer address pointer, plus the timing information, for the frame of video data just stored or about to be stored in the data storage memory 204 by the video decoder unit 202.

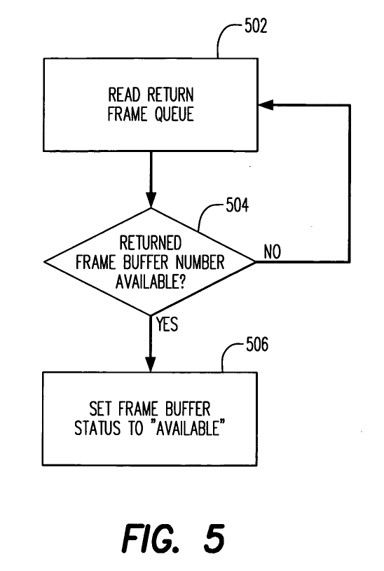

FIG. 5 is a flow chart that illustrates still another aspect of operation of the frame tracker block 212. In particular, the process illustrated in FIG. 5 is concerned with releasing frame buffer locations from “locked” status.

At 502 in FIG. 5, the frame tracker block 212 reads the return frame queue 220 via the demultiplexer 222. At 504, the frame tracker block 212 determines whether a returned frame buffer number is available for reading from the return frame queue 220. If not, the process loops back to 502/idles. However, if at 504 the frame tracker block 212 determines that a returned frame buffer number is available for reading from the return frame queue 220, then the process advances to 506. At 506, the frame tracker block 212 accesses the register which corresponds to the returned frame buffer number and changes the status indicated in the register from “locked” to “available”.

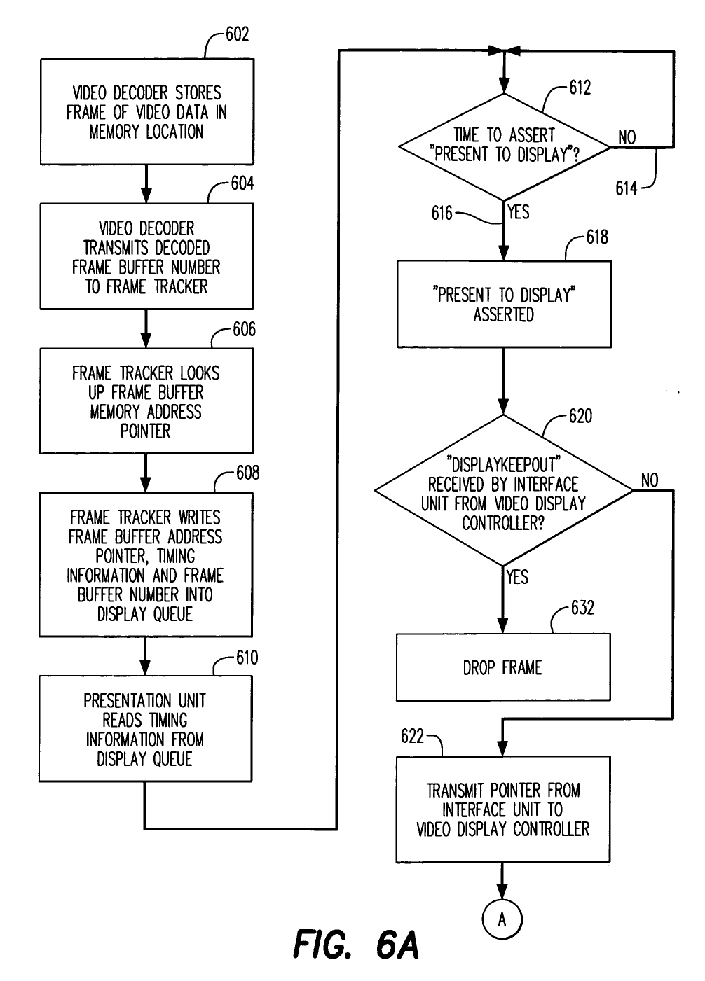

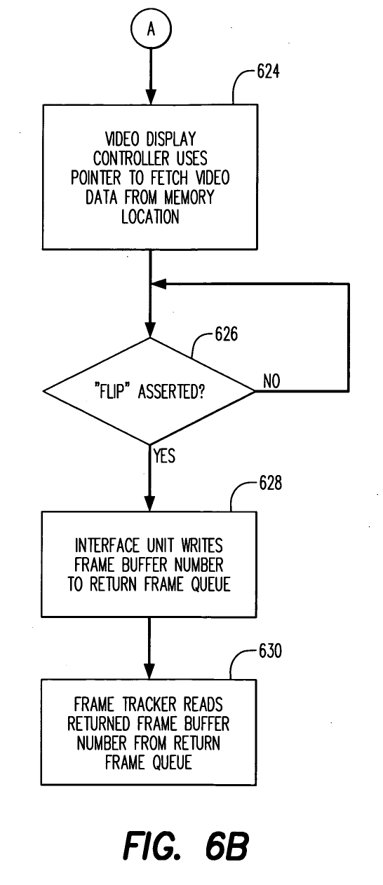

FIGS. 6A and 6B together form a flow chart that illustrates a process that may be performed by the decoding/buffering block 104. From one point of view, the process of FIGS. 6A and 6B may be considered to represent the “life cycle” of a frame of video data decoded by the video decoder unit 202.

At 602 in FIG. 6A, the video decoder unit 202 stores a frame of decoded video data in a frame buffer location in the data storage memory 204. The data transfer path that allows this video frame data storing operation to occur is indicated at 232 in FIG. 2. From previous discussion, it will be appreciated that 602 may follow the process illustrated in FIG. 3, and that the particular frame buffer location used to store the current decoded video data frame corresponds to the frame buffer number requested by the video decoder unit 202 (via signal path 224, FIG. 2) at 302, 304 in FIG. 3 and provided by the frame tracker block 212 (via signal path 226) at 308 in FIG. 3.

At 604 in FIG. 6A, the video decoder unit 202 transmits the corresponding decoded frame buffer number to the frame tracker block 212 (via signal path 228), as reflected by previously discussed blocks 402, 404 in FIG. 4.

At 606 in FIG. 6A, the frame tracker block 212 looks up the frame buffer pointer address for the buffer location in question, as previously discussed at 406 in FIG. 4. (In association with performing this function, the frame tracker block 212 also looks up the frame timing information, as previously discussed at 408 in FIG. 4.)

At 608 in FIG. 6A, the frame tracker block 212 loads into the next (last) queue location in the display queue 214, the frame buffer number, the frame buffer pointer address and the timing information for the video data frame just stored in the corresponding buffer memory location. The operation represented at 608 has previously been discussed in connection with 412 in FIG. 4.

At 610 in FIG. 6A, the presentation unit 218 reads from the head of the display queue 214 the timing information for the stored frame of video data which corresponds to the entry at the head of the display queue 214. (Transmission of the timing information from the display queue 214 to the presentation unit 218 is indicated at 234 in FIG. 2.)

As indicated at 612 in FIG. 6A, the presentation unit 218 next determines whether the time has come to display the frame of video data represented by the entry at the head of the display queue 214. The presentation unit 218 makes this determination by using the timing information for the frame of video data. As indicated by branch 614 from decision block 612, the presentation unit 218 waits for the appropriate time to trigger display of the frame of video data, as determined in accordance with the timing information. When the appropriate time arrives, as indicated by branch 616 from decision block 612, the process advances to 618. At 618, the presentation unit 218 asserts a “present to display” signal 236 (FIG. 2) to the interface unit 216.

As represented by decision block 620 in FIG. 6A, the interface unit 216 responds to the “present to display” signal by determining whether the “display_keepout” signal 238 (FIG. 2) from the video display controller 210 is currently asserted. The video display controller 210 asserts the “display_keepout” signal at times when the video display controller 210 is currently retrieving a video data frame or field from the data storage memory 204. As will be more completely understood after an ensuing discussion, if the video display controller 210 is currently retrieving video data from the data storage memory 204, it is doing so by using a frame buffer pointer address that was previously loaded into the video display controller 210 by the interface unit 216. The purpose of the “display_keepout” signal is to prevent (inhibit) the interface unit 216 from disrupting the video display controller's fetching of video data. Such disruption may occur if the interface unit 216 were to update the frame buffer pointer address while the video data was being fetched, and this may result in “tearing” of the image displayed by the display device 106 (FIG. 1) under the control of the video display controller 210.

If the interface unit 216 determines at decision block 620 in FIG. 6A that the “display_keepout” signal is not currently asserted, then the process advances to 622. At 622, the interface unit 216 applies a “pop” operation 240 (FIG. 2) to the display queue 214, thereby causing the frame buffer number and the frame buffer pointer address stored at the top of the display queue 214 to be transmitted to the interface unit 216 from the display queue 214, as indicated at 242 in FIG. 2. The interface unit 216 then writes the frame buffer pointer address to the video display controller 210, as indicated at 244 in FIG. 2.

The process then advances to 624 (FIG. 6B). At 624, the video display controller 210 uses the frame buffer pointer address (which had been “popped” from the head of the display queue 214 to the interface unit 216, and then transmitted from the interface unit 216 to the video display controller 210) to fetch, from the data storage memory 204, the frame of video data which had been stored by the video decoder unit 202 in the data storage memory 204 at the location indicated by the frame buffer pointer address. Fetching of the video data by the video display controller 210 from the data storage memory 204 is indicated at 246 in FIG. 2. The video display controller 210 uses the fetched frame of video data to drive the display device 106 (FIG. 1) to display the image which corresponds to the frame of video data. Upon completion of the display of the second field of the frame, the video display controller 210 asserts a “flip” signal 248 (FIG. 2) that is provided to the interface unit 216 of the frame buffer/queue manager 208. The “flip” signal 248 signifies that the video display controller 210 no longer has need to access the video data for the current frame, so that the frame buffer location can be released. The frame buffer/queue manager 208 then effects release of the frame buffer location, in a manner described immediately below.

Decision block 626 in FIG. 6B represents a determination by the interface unit 216 as to whether the video display controller 210 has asserted the “flip” signal 248. If not, the interface unit 216 waits to perform the interaction with the return frame queue 220, as described below. However, once the interface unit 216 determines that the “flip” signal 248 is asserted, then the process advances to 628 in FIG. 6B. At 628, the interface unit 216 executes a “push” operation (250 in FIG. 2) to write the frame buffer number for the corresponding frame of video data to the return frame queue 220. (Transmission of the frame buffer number to the return frame queue 220 is indicated at 252 in FIG. 2.)

The process then advances to 630. At 630, and as previously discussed in connection with 502 and 504 in FIG. 5, the frame tracker block 212 reads the returned frame buffer number from the return frame queue 220. This leads to 506 in FIG. 5, wherein, as mentioned before, the frame tracker block 212 changes the status of the corresponding frame buffer location from “locked” to available”. Consequently, the frame buffer location is now available to be reported to the video decoder unit 202 (as discussed above in connection with FIG. 3) for use in storing another frame of video data (602 in FIG. 6A).

Referring again to decision block 620 in FIG. 6A, if the interface unit 216 determines at that point that the “display_keepout” signal 238 is asserted at a time when the presentation unit 218 asserted the “present to display” signal 236, then the process advances from decision block 620 to 632 (FIG. 6A). At 632, the video data frame represented by the entry at the head of the display queue 214 is dropped. That is, the interface unit 216 does not send the frame buffer pointer address for that frame to the video data controller, in order to avoid tearing the image that is currently being displayed. Instead, the interface unit 216 “pops” the frame buffer number from the display queue 214 and then immediately “pushes” the frame buffer number to the return frame queue 220 as a returned frame buffer number. The returned frame buffer number is then read from the return frame queue 220 by the frame tracker block 212 (as in 630 in FIG. 6B and as in the process of FIG. 5) so that the corresponding frame buffer location is made available for re-use.

It was noted above that the frame tracker block 212 is (at least in some embodiments) coupled to the return frame queue 220 by a demultiplexer 222. In effect, this allows the return frame queue 220 to be programmable. That is, the demultiplexer 222 may be programmed (e.g., by the above-mentioned microprocessor, which may control over-all operation of the system 100 and which is not shown) to select a particular position in the return frame queue 220 from which to transmit a returned frame buffer number to the frame tracker block 212.

Each push operation from the interface unit 216 to the return frame queue 220 represents a video data frame that has been sent to the video display controller 210. Each time a frame buffer number is pushed to the return frame queue 220 by the interface unit 216, the return frame queue moves one position forward. By programming the selected point in the return frame queue 220 via the demultiplexer 222, it is possible to keep the corresponding frame of video data from being released back to the frame tracker block 212. This allows frames to remain active in the display system for more than one frame period. This feature may be useful, for example, when the video display controller 210 needs to post-process frames of video data, since post-processing algorithms may require access to more than one frame during a given frame period.

The demultiplexer 222 may be programmed, for example, to select a particular point in the return frame queue 220 from which to get the returned frame buffer number. In a more specific example, the demultiplexer 222 may select location 3 in the return frame queue 220, in which case a returned frame buffer number which is coming from the interface unit 216 needs to pass through three locations in the return frame queue 220 before being returned to the frame tracker block 212. Consequently, in this particular example, the frame of video data experiences three “pushes” or frame periods of delay, during which it remains accessible to the video display controller 210 for post-processing or other operations. In other words, the frame of video data is not returned (released from the buffer) for three frame periods.

Turning to another topic, in the above discussion of the video display controller 210, it was assumed that the video display controller had a single register (not separately shown) in which to store the latest frame buffer pointer address provided by the interface unit 216. Alternatively, however, the video display controller 210 may have two frame buffer address registers (not separately shown) and may ping-pong between the two registers. That is, while the video display controller 210 is using the frame buffer address pointer in one of the registers to access a frame of video data in the data storage memory 204, the other register is available for the interface unit to write in the frame buffer address pointer for the next frame of video data. When the video display controller 210 is finished accessing one frame of video data, it switches to the other register to access the next frame of video data. In this case, the purpose of the “display_keepout” signal is to prevent the interface unit 216 from updating the frame buffer address pointer while the video display controller 210 is switching from one frame buffer address register to the other.

With a frame buffer/queue manager arrangement like that described above, a display device controlled by a video display controller may be conveniently driven from a variety of video signal sources notwithstanding that the signal(s) provided by the source(s) may be asynchronous to the display device.

The above descriptions and depictions of processes should not be taken to imply a fixed order of performing the process stages. Rather, the process stages may be performed in any order that is practicable. Further, two or more instances of a process described/depicted above may be performed in an overlapping fashion such that a portion of one instance of the process is performed simultaneously or virtually simultaneously with a different portion of another instance of the process.

Although only one video data source is depicted in FIG. 1, in some embodiments two or more video data sources may be interfaced to the decoding/buffering block 104, and an arrangement may be provided to select among the video data sources as to which is currently used to provide a video signal feed to the decoding/buffering block. In some embodiments, selection of a video data source may be based on user input. If necessary, the decoding/buffering block may include more than one type of video decoder unit so that the decoding/buffering block is able to handle more than one type of input video signal.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
storing a frame of video data in a location in a memory;
transmitting, to a queue manager circuit, a pointer to the location;
storing the pointer in a queue;
transmitting the pointer from the queue to an interface unit; and
transmitting the pointer from the interface unit to a video display controller.

2. The method of claim 1, further comprising:
transmitting a signal from the video display controller to the interface unit, said signal to selectively inhibit transmission of the pointer from the interface unit to the video display controller.

3. The method of claim 1, further comprising:
transmitting the frame of video data from the memory to the video display controller.

4. The method of claim 1, further comprising:
transmitting a signal from the video display controller to the interface unit, said signal to indicate that the video display controller has completed displaying a video signal frame.

5. The method of claim 1, further comprising:
transmitting a timing signal from a presentation unit to the interface unit.

6. The method of claim 5, further comprising:
transmitting frame timing information from the queue to the presentation unit.

7. The method of claim 1, further comprising:
the queue manager transmitting to a video decoder unit an indication as to a location in memory in which the video decoder unit is to store a next frame of video data.

8. The method of claim 7, further comprising:
the video decoder transmitting to the queue manager a decoded frame buffer number.

9. The method of claim 8, wherein:
the decoded frame buffer number is used to determine the pointer stored in the queue.

10. An apparatus comprising:
a first queue to store a sequence of memory pointers, each of said memory pointers indicative of an address in memory for a field or frame of video data;
an interface unit coupled to the first queue to selectively receive the memory pointers from the first queue and to selectively transmit the memory pointers to a video display controller;
a presentation unit coupled to the first queue and to the interface unit, the presentation unit to receive video field or frame timing information from the first queue and to control timings at which the interface unit transmits the memory pointer to the video display controller;
a second queue coupled to the interface unit to receive and store transmitted frame buffer numbers; and
a frame tracker coupled to a video data source, to the first queue and to the second queue, the frame tracker to transmit the memory pointers to the first queue, and to receive the transmitted frame buffer numbers from the second queue.

11. The apparatus of claim 10, wherein:
the interface unit receives a signal from the video display controller to selectively inhibit the interface unit from transmitting a next memory pointer.

12. The apparatus of claim 10, wherein:
the interface unit receives a signal from the video display controller to indicate to the interface unit that the video display controller has completed displaying a field or frame of video data.

13. The apparatus of claim 10, wherein:
the first queue stores, for each field or frame available for presentation to the video display controller:
(a) a corresponding one of said memory pointers;
(b) a corresponding frame buffer number; and
(c) respective timing information.

14. The apparatus of claim 10, further comprising:
a demultiplexer which couples the second queue to the frame tracker.

15. A system comprising:
a display unit;
a video display controller to supply video data to the display unit;
a memory; and
a queue manager coupled to the video display controller to supply to the video display controller a sequence of pointers to locations in the memory, the locations to store the video data, the queue manager including:
a first queue to store a sequence of memory pointers, each of said memory pointers indicative of an address in memory for a field or frame of video data;
an interface unit coupled to the first queue to selectively receive the memory pointers from the first queue and to selectively transmit the memory pointers to the video display controller;
a presentation unit coupled to the first queue and to the interface unit, the presentation unit to receive video field or frame timing information from the first queue and to control timings at which the interface unit transmits the memory pointer to the video display controller;
a second queue coupled to the interface unit to receive and store transmitted frame buffer numbers; and
a frame tracker coupled to a video data source, to the first queue and to the second queue, the frame tracker to transmit the memory pointers to the first queue, and to receive the transmitted frame buffer numbers from the second queue.

16. The system of claim 15, wherein:
the interface unit receives a signal from the video display controller to selectively inhibit the interface unit from transmitting a next memory pointer.

17. The system of claim 15, wherein:
the interface unit receives a signal from the video display controller to indicate to the interface unit that the video display controller has completed displaying a field or frame of video data.

18. The system of claim 15, wherein:
the first queue stores, for each field or frame available for presentation to the video display controller:
(a) a corresponding one of said memory pointers;
(b) a corresponding frame buffer number; and
(c) respective timing information.

19. The system of claim 15, further comprising:
a demultiplexer which couples the second queue to the frame tracker.
